(19) United States
(12) Patent Application Publication
(10) Pub. No.: US 2025/0310351 A1
(43) Pub. Date: Oct. 2, 2025

(54) THREAT-INFORMED ADVERSARY ATTACK SIMULATION

(71) Applicant: Fortinet, Inc., Sunnyvale, CA (US)

(72) Inventors: Anil Uday Aphale, Maharashtra (IN); Shravan Kumar Budharap, Maharashtra (IN); Nishant Ranjan, Delhi (IN)

(73) Assignee: Fortinet, Inc., Sunnyvale, CA (US)

(21) Appl. No.: 18/619,834

(22) Filed: Mar. 28, 2024

(51) Int. Cl. H04L 9/40

(52) U.S. Cl. CPC H04L 63/1416; H04L 63/1441

(57) ABSTRACT

A dynamic adversary profile is generated for a simulated attack on components of the enterprise network by selecting a profile of at least one specific threat group. The simulated attack is based on historical attack data, threat intelligence feeds, and real-time monitoring of adversary profiles. One or more relevant adversary group profiles is selected. An attack pattern (e.g., an APT attack pattern) is simulated on the components by injecting data packets based on the specific threat group without malicious components of the specific threat group to test security defenses of the components. Logs are collected from the simulated attack pattern. Based on results of the simulated attack pattern, defenses to the simulated attack on components are measured. Optionally, a security action concerning at least one of the components to better protect against an actual attack.

### FIELD OF THE INVENTION

The invention relates generally to computer network security, and more specifically, for assessing threat defenses by simulating an attack pattern of Advance Persistent Threat (APT) or adversaries using real-time threat intelligence.

### BACKGROUND

Modern organizations invest heavily in advanced defense technologies to safeguard against cyberattacks. In particular, an APT is a prolonged and targeted cyberattack in which an intruder gains access to a network and remains undetected for an extended period. It can be difficult to detect, analyze, and remediate APT attacks, as well-funded and government-supported groups have the means to execute well-planned strategies.

Furthermore, there remains a significant challenge in validating and measuring the effectiveness of deployed defenses. Current practices, such as Red Team assessments, primarily focus on external threats, overlooking the potential risks associated with insider threats and social engineering attacks, which are inherently human-oriented and not always fully addressed by existing assessment methodologies.

These insider threats and social engineering attacks typically originate from within the network, often initiating after circumventing perimeter defenses. The trust associated with internal security implementations tends to be higher, providing a potential avenue for attackers to exploit. Once inside, lateral movement becomes relatively easier, and malicious activities may go undetected depending on the signatures and detection capabilities of deployed solutions.

What is needed is a robust technique for assessing threat defenses by simulating an attack pattern of APT using real-time threat intelligence.

### SUMMARY

To meet the above-described needs, methods, computer program products, and systems for assessing threat defenses by simulating an attack pattern of APT using real-time threat intelligence.

In one embodiment, a dynamic adversary profile is generated for a simulated attack on components of the enterprise network by selecting a profile of at least one specific threat group. The simulated attack is based on historical attack data, threat intelligence feeds, and real-time monitoring of adversary profiles. One or more relevant APT group profiles is selected.

In another embodiment, an attack pattern (e.g., an ATP attack) is simulated on the components by injecting data packets based on the specific threat group without malicious components of the specific threat group to test security defenses of the components.

In still another embodiment, logs are collected from the simulated attack. Based on results of the simulated attack, defenses to the simulated attack on components are measured. Optionally, a security action concerning at least one of the components to better protect against an actual attack.

Advantageously, computer networks are improved with better performance from reduced malicious activity, especially APT attacks.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a sequential flow of assessing threat defenses by simulating an attack pattern of APT attack using real-time threat intelligence, according to some embodiments.

FIG. 2 is a more detailed block diagram illustrating a system for assessing threat defenses by simulating an attack pattern of APT attack using real-time threat intelligence, according to an embodiment.

FIGS. 3 and 4 are more detailed block diagrams illustrating components of the system of FIG. 1 during a simulated APT attack, according to an embodiment.

FIG. 5 is a flow diagram illustrating a method for assessing threat defenses by simulating an APT attack against a specific attack group using real-time threat intelligence, according to an embodiment.

FIG. 6 is a block diagram illustrating an example computing device for the system of FIG. 1, according to an embodiment.

### DETAILED DESCRIPTION

Methods, computer program products, and systems for assessing threat defenses by simulating an attack pattern of APT attack using real-time threat intelligence. The following disclosure is limited only for the purpose of conciseness, as one of ordinary skill in the art will recognize additional embodiments given the ones described herein.

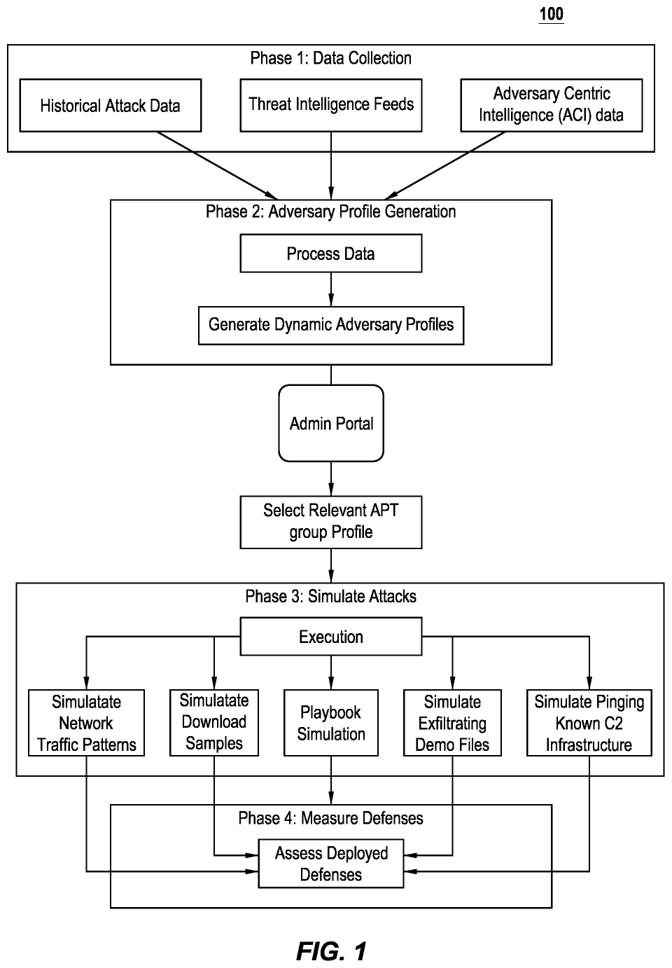

### I. Systems for Adversary Threat Simulation (FIGS. 1-4)

FIG. 1 is a high-level block diagram illustrating phases of a system 100 for identifying attacks to an active resource of the enterprise network by trusted devices, according to an embodiment. In phase 1, data collection includes historical attack data, threat intelligence feeds, and adversary centric intelligence (ACI) data. Next, phase 2 includes processing data from phase 1 to generate dynamic adversary profiles. Simulated attacks are then launched in phase 3 and evaluation of defenses occurs by assessment in phase 4.

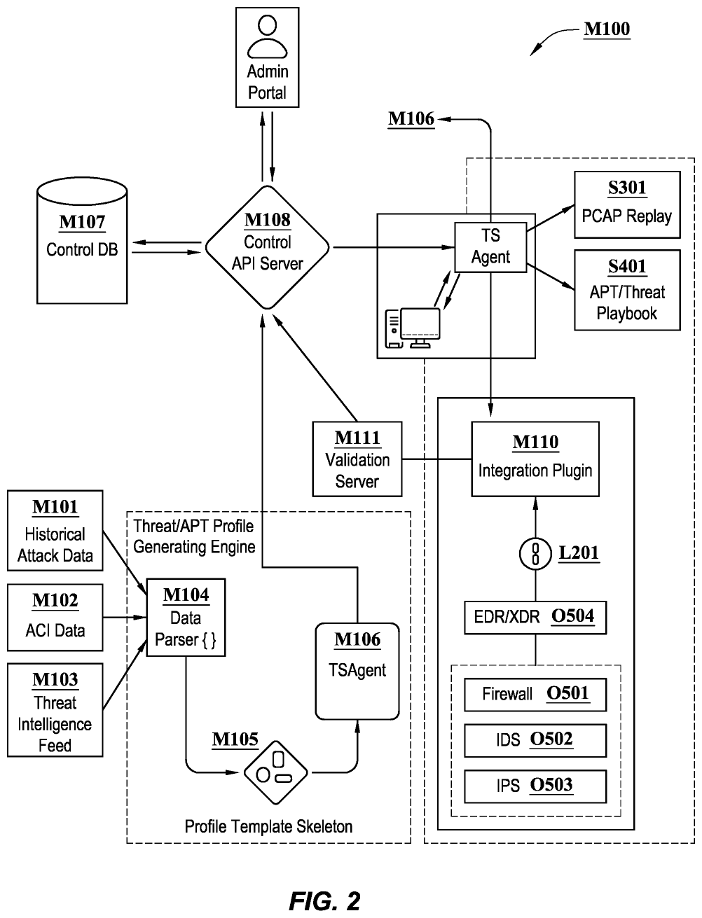

In an embodiment of FIG. 2, the main architecture of a threat simulation system or threat simulation device, denoted as M100, provides a comprehensive system for simulating known Threat Actors/APT group attacks on computer systems and networks. Leveraging historical attack data M101, ACI data M102, and threat intelligence feeds M103, the system employs a Threat/APT Profile Generating Engine to meticulously generate Threat Actor/APT profiles. These profiles encapsulate a range of critical information pertaining to Threat Actors/APT groups, including attack paths, malicious artifacts, initial access details, campaign specifics, and chronological timelines. The invention here described can include all permutations of these variations, configurations, implementations, example implementations and examples.

Within the Threat Actor/APT Profile Generating Engine, a data parser M104 plays a pivotal role by parsing, organizing, and structuring the input data into a profile template skeleton M105. Subsequently, an object skeleton is constructed for the identified Threat Actor/APT group. Once the object skeleton is established, the Threat Actor/APT group Profile Generating Engine proceeds to synthesize an executable known as TS Agent M106. This executable encapsulates a repertoire of functions, including behavior mimic functions, utilized artifacts, malicious trigger functions, interruption trigger functions, and the Threat Actor/APT group's attack path.

Historical attack data M101, ACI data M102, and threat intelligence feeds M103 serve as the primary input data sources. Information gathered includes attack paths, malicious artifacts, initial access details, campaign information, and chronological timelines associated with the Threat Actor/APT group. The data parser M104 within the Threat Actor/APT group Profile Generating Engine processes and structures the received data into a profile template skeleton M105. An object skeleton is then generated for the respective Threat Actor/APT group. The Threat Actor/APT group Profile Generating Engine transforms the object skeleton into an executable known as TS Agent M106. TS Agent incorporates functions that mimic Threat Actor/APT group behavior, identify malicious artifacts, trigger malicious and interruption functions, and map the Threat Actor/APT group's attack path.

Subsequently, the Threat Actor/APT group Profile Generating Engine pushes the Threat Simulation Agent (TS Agent M106) to the Control API Server M108, control API server establishing a connection to the storage database known as the Control DB M107. The Control DB comprehensively houses all generated TS Agents corresponding to the identified APT/Threat groups, thereby rendering them accessible and visible through the administrative portal. The administrative portal facilitates the selection of specific parameters to simulate APT group attacks on computer systems and networks. These selections are then forwarded to Control API Server M108, which, in turn, communicates with TS Agent (M106) an internal agent installed on assets within the target network to simulate on the network. Network security devices, such as Firewall O501, IDS O502, and IPS O503, are linked and integrated (L201) through integration plugin M110. This integration plugin M110 enables the core simulation model/TS Agent to retrieve real-time logs and data generated during the Threat Actor/APT group attack simulations from any security device within the network. Subsequently, this information is transmitted to Control API Server M108 through a validation server M111. The validation server M111 processes the logs and data received from the integration plugin M110 to determine whether the Threat Actor/APT group attack simulation has been detected and prevented or not. This validation helps assess the effectiveness of the security measures in place, providing valuable insights into the network's resilience against Threat Actor/APT group threats.

In some embodiments, TS Agent M106 executes two distinct methods: PCAP Replay S301 and Threat Actor/APT group playbook S401 based on a profile template skeleton M105 and utilizes available data to carry out the simulation.

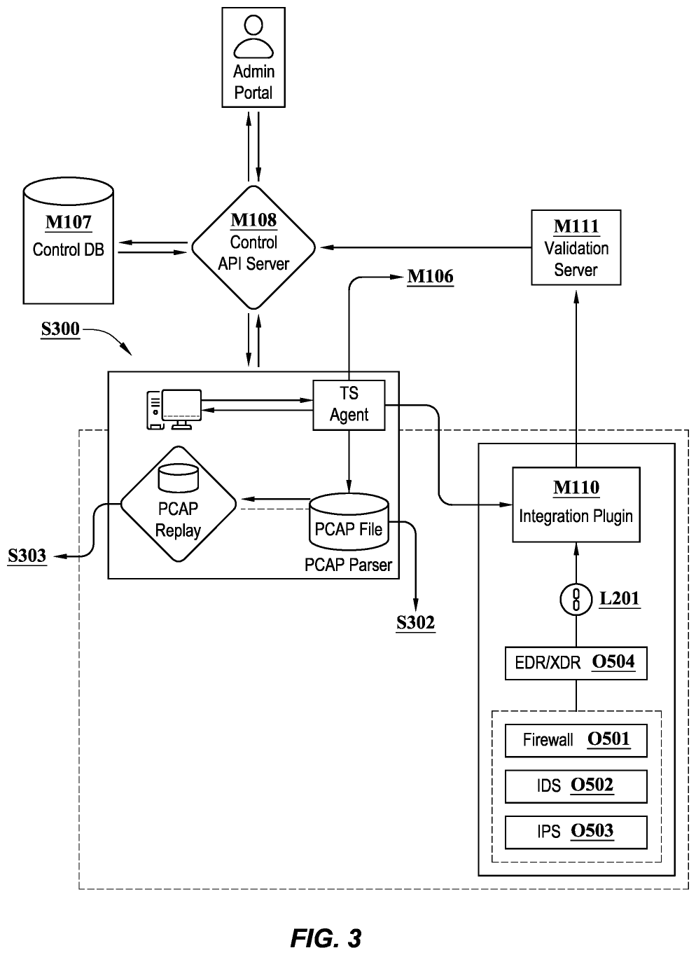

As shown in FIG. 3, one technique S300 for simulating a known Threat Actor/APT group attack on a computer network involves several key steps. Initially, a packet capture (PCAP) file representing transmitted packet fragments during the malicious attack is accessed. Notably, the malicious PCAP file corresponding to the selected Threat Actor/APT group attack is embedded within TS Agent M106 during the Threat Actor/APT group profile generation stage.

Once TS Agent M106 is installed on assets within the target network, the PCAP file undergoes modification by the PCAP Parser S302. This modification entails changing the respective source and destination, resulting in the creation of a modified PCAP file specific to the selected Threat Actor/APT group. Subsequently, TS Agent initiates the simulation and replays S303 the modified malicious PCAP file within the target network. During the execution of the simulation, TS Agent communicates with the integration plugin M111. This plugin is responsible for fetching the logs and data generated by the network's security devices in response to the replay (S303) of the modified malicious PCAP file. The information collected is then transmitted to Control API Server M108 through a validation server M111. The validation server M111 processes the logs and data received from the integration plugin M110 to assess whether the Threat Actor/APT group attack simulation was detected and prevented or not. This comprehensive evaluation enables the admin portal to view the results of the simulation, providing valuable insights into the network's resilience against Threat Actor/APT group threats.

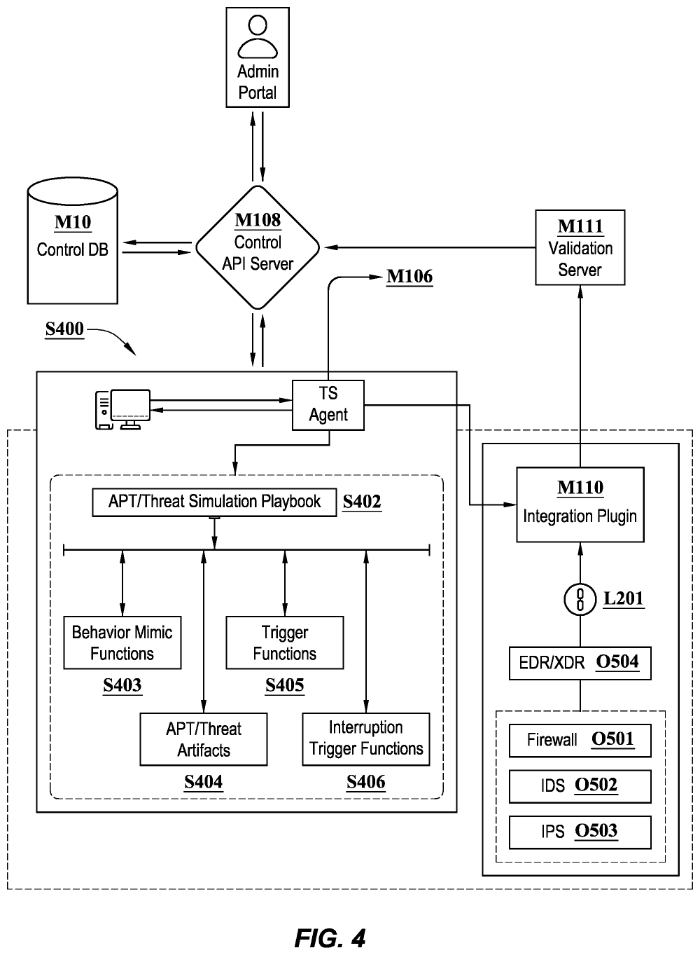

As shown in FIG. 4, another technique S400 for simulating a known Threat Actor/APT group attack on the target assets and computer network includes: running a Threat Actor/APT group simulation playbook S402 with respective to the selected Threat Actor/APT group. Threat Actor/APT group simulation playbook S402 can include all series of permutations depending on the APT attack profile, but the main contrasting features includes Behavior Mimic Functions S403, Threat Actor/APT group Artifacts S404, Trigger Functions S405, Interruption Trigger Function S406.

Behavior Mimic Functions S403 in TS Agent M106 contains the series of dummy malicious functions and followed attack path functions, that are being carried out by an actual Threat Actor/APT group during its campaign. It allows installed agent on computer network to mimic the behavior and replicate the Threat Actor/APT group attack path, creating a behavioral logs and event logs, enabling network security devices such as EDR (Endpoint Detection and Response), XDR (Extended Detection and Response) O504, Firewall O501, IDS (intrusion detection system) O502, IPS (intrusion prevention system) O503; to render on the activity.

Threat Actor/APT group artifacts S404 in TS Agent M106 contains the dummy binary and other dummy executable files that mimics the working of original malicious executables thereby creating an authentic, harmless copy of the attack occurring on the target network.

Trigger functions S405 gather comprehensive trigger and alert logs pertaining to the execution of malicious artifacts on the target machine where the TS Agent is installed, with respect to the Threat Actor/APT group attack path. These logs are then transmitted to the admin portal through the Control API Server M108, providing a detailed overview of the entire process and trigger points.

The Interruption Trigger Functions S406 within the TS Agent M106, play a crucial role in maintaining vigilant oversight over the execution of key components such as the Behavior Mimic Function (S403) and Threat Actor/APT group artifacts (S404). This functionality empowers the installed TS Agent to persistently monitor the progress of the attack simulation path. In the event of any interruptions introduced by security solutions like EDR/XDR within the network, the TS Agent adeptly responds by ensuring the continuity of the simulation, thereby allowing for the seamless progression through the various steps of the Threat Actor/APT group attack path.

This built-in capability serves a dual purpose. Firstly, it ensures the successful completion of the Threat Actor/APT group attack simulation, safeguarding against potential disruptions caused by security solutions. Secondly, it provides a mechanism for security devices to meticulously examine and assess potential alerts at each step along the Threat Actor/APT group simulation attack path. By proactively addressing interruptions and facilitating uninterrupted simulation, the TS Agent contributes to a comprehensive and thorough evaluation of the network's resilience against sophisticated Threat Actor/APT groups.

In essence, the Interruption Trigger Functions stand as a pivotal feature within TS Agent M106, fortifying the integrity and comprehensiveness of Threat Actor/APT group attack simulations while fostering a heightened awareness of security alerts within the network infrastructure. This robust mechanism ensures that the simulation process unfolds cohesively, enabling security professionals to derive valuable insights and fortify the defensive posture against evolving cyber threats.

During the execution of the simulation, TS Agent communicates with the integration plugin M111. This plugin is responsible for fetching the logs and data generated by the network's security devices in response to Threat Actor/APT group simulation playbook S402. The information collected is then transmitted to Control API Server M108 through a validation server M111. The validation server M111 processes the logs and data received from the integration plugin M110 to assess whether the APT group attack simulation was detected and prevented or not. This comprehensive evaluation enables the admin portal to view the results of the simulation, providing valuable insights into the network's resilience against Threat Actor/APT group threats.

This adversary simulation generates an authentic replication of the attack environment.

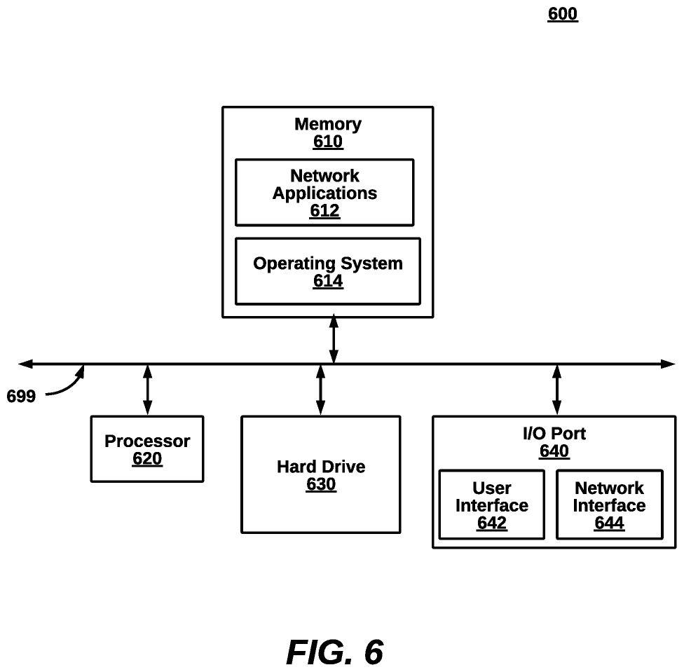

Other embodiments of the system M100 can include additional components that are not shown in FIG. 1, such as routers, switches, network gateways, and firewalls, access points and stations. The components of system 100 can be implemented in hardware, software, or a combination of both. An example implementation is shown in FIG. 6.

In one embodiment, the components of the system M100 are coupled in communication over a private network connected to a public network, such as the Internet. In another embodiment, system M100 is an isolated, private network, or alternatively, a set of geographically dispersed LANs. The components can be connected to the data communication system 199 via hard wire (e.g., Threat/APT Profile Generating Engine, API server, and validation server). The components can also be connected via wireless networking (e.g., wireless stations). The data communication network 199 can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802, 11r, 802.11be, Wi-Fi 6, Wi-Fi 6E, Wi-Fi 7 and the like. Components can use IPV4 or Ipv6 address spaces.

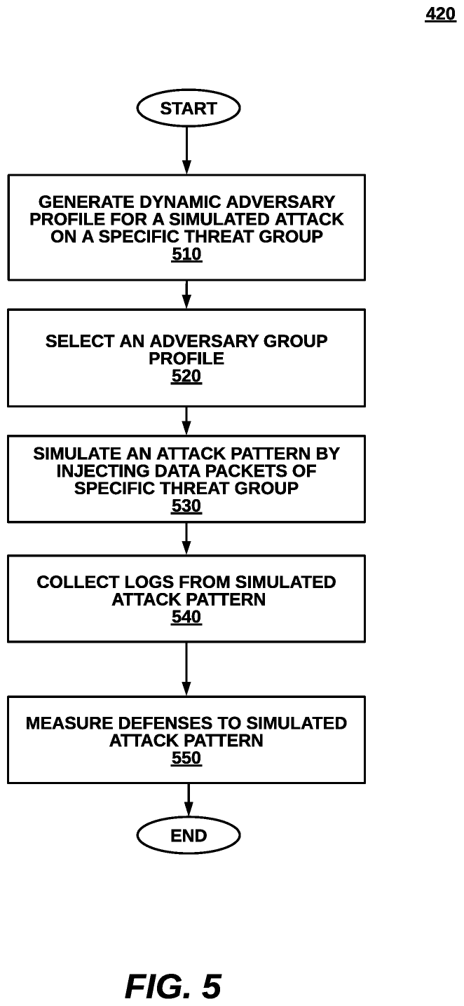

### II. Methods for Adversary Threat Simulation (FIG. 5)

FIG. 5 is a high-level flow diagram of a method 500 for assessing threat defenses by simulating an APT attack against a specific attack group using real-time threat intelligence, according to an embodiment. The method 500 can be implemented by, for example, system 100 of FIG. 1. The specific grouping of functionalities and order of steps are a mere example as many other variations of method 400 are possible, within the spirit of the present disclosure. Other variations are possible for different implementations.

At step 510, a dynamic adversary profile is generated for a simulated attack on components of the enterprise network by selecting a profile of at least one specific threat group. The simulated attack is based on historical attack data, threat intelligence feeds, and real-time monitoring of adversary profiles.

At step 520, one or more relevant adversary group profile is selected.

At step 530 an attack pattern (e.g., an ATP attack pattern) is simulated on the components by injecting data packets based on the specific threat group without malicious components of the specific threat group to test security defenses of the components.

At step 540, logs are collected from the simulated attack pattern.

At step 550, based on results of the simulated attack pattern, defenses to the simulated attack on components are measured. Optionally, a security action concerning at least one of the components to better protect against an actual APT attack.

### III. Computing Device for Adversary Threat Simulation (FIG. 6)

FIG. 6 is a block diagram illustrating a computing device 600 for use in the system 100 of FIG. 1, according to one embodiment. The computing device 600 is a non-limiting example device for implementing each of the components of the system 100. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VOIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance; FORTIRECON; and FORTICART), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A computer-implemented method in a threat simulation system on an enterprise network, and at least partially implemented in hardware, to perform a method for assessing threat defenses by simulating an attack pattern using real-time threat intelligence, the method comprising:
generating a dynamic adversary profile for a simulated attack on components of the enterprise network by selecting a profile of at least one specific threat group, wherein the simulated attack is based on historical attack data, threat intelligence feeds, and real-time monitoring of adversary profiles;
selecting relevant adversary group profile;
simulating an attack pattern on the components by injecting data packets based on the specific threat group without malicious components of the specific threat group to test security defenses of the components;
collecting logs from the simulated attack pattern; and
based on results of the simulated attack pattern, measure defenses to the simulated attack on components and take a security action concerning at least one of the components.

2. The method of claim 1, wherein the simulated attack pattern comprises one or more of simulating network traffic patterns, simulating download samples, playbook simulation, simulating exfiltrating demonstration files and simulating pinging known C2 infrastructure.

3. The method of claim 1, wherein the simulated attack pattern comprises a simulated Advanced Persistent Threat (APT) attack pattern.

4. A non-transitory computer-readable medium in a threat simulation system on an enterprise network, and at least partially implemented in hardware, to perform a method for assessing threat defenses by simulating an attack pattern using real-time threat intelligence, the method comprising:
generating a dynamic adversary profile for a simulated attack on components of the enterprise network by selecting a profile of at least one specific threat group, wherein the simulated attack is based on historical attack data, threat intelligence feeds, and real-time monitoring of adversary profiles;
selecting relevant adversary group profile;
simulating an attack pattern on the components by injecting data packets based on the specific threat group without malicious components of the specific threat group to test security defenses of the components;
collecting logs from the simulated attack pattern; and
based on results of the simulated attack pattern, measure defenses to the simulated attack on components and take a security action concerning at least one of the components.

5. A threat simulation system on an enterprise network, and at least partially implemented in hardware, to perform a method for assessing threat defenses by simulating an attack pattern using real-time threat intelligence, the deceptive proxy device comprising:
a processor;
a network interface communicatively coupled to the processor and to a data communication network; and
a memory, communicatively coupled to the processor and storing:
a threat profile generator to generate a dynamic adversary profile for a simulated attack on components of the enterprise network by selecting a profile of at least one specific threat group, wherein the simulated attack is based on historical attack data, threat intelligence feeds, and real-time monitoring of adversary profiles;
a profile selector to select a relevant adversary group profile;
an attack simulator to simulate an attack pattern on the components by injecting data packets based on the specific threat group without malicious components of the specific threat group to test security defenses of the components; and
an attack assessor to collect logs from the simulated attack pattern, and
based on results of the simulated attack pattern, measure defenses to the simulated attack on components and take a security action concerning at least one of the components.
